(19) United States
(12) Patent Application Publication
(10) Pub. No.: US 2024/0242610 A1
(43) Pub. Date: Jul. 18, 2024

(54) INFORMATION PROCESSING DEVICE

(71) Applicant: TOYOTA JIDOSHA KABUSHIKI KAISHA, Toyota-shi (JP)

(72) Inventor: Kazuki MATSUMOTO, Ogaki-shi (JP)

(73) Assignee: TOYOTA JIDOSHA KABUSHIKI KAISHA, Toyota-shi (JP)

(21) Appl. No.: 18/479,449

(22) Filed: Oct. 2, 2023

(30) Foreign Application Priority Data
Jan. 17, 2023 (JP) 2023-005150

(51) Int. Cl. G08G 1/14; G06Q 10/02; G06Q 50/30

(52) U.S. Cl. CPC G08G 1/148; G06Q 10/02; G06Q 50/30; G08G 1/144

(57) ABSTRACT

In the information processing device according to the present disclosure, the control unit receives a first request requesting information on a second vehicle having a power supply function from a first terminal corresponding to the first vehicle. The control unit acquires the scheduled parking location and the scheduled parking time period of the second vehicle. The control unit generates first information including the scheduled parking location and the scheduled parking time period of the second vehicle, and transmits the generated first information to the first terminal.

### CROSS-REFERENCE TO RELATED APPLICATION

This application claims priority to Japanese Patent Application No. 2023-005150 filed on Jan. 17, 2023, incorporated herein by reference in its entirety.

### BACKGROUND

### 1. Technical Field

The present disclosure relates to information processing devices.

### 2. Description of Related Art

Japanese Unexamined Patent Application Publication No. 2021-167759 (JP 2021-167759 A) discloses a configuration that acquires the current locations of a plurality of vehicles, searches for a recommended place for energy transfer between the vehicles based on the current locations of the vehicles, and provides information on the found recommended place for energy transfer to the vehicles. Japanese Unexamined Patent Application Publication No. 2013-192285 (JP 2013-192285 A) discloses a configuration that causes a vehicle to send a power supply request signal requesting power supply to a traction battery of the vehicle and including the current location of the vehicle to other vehicles around the vehicle by vehicle-to-vehicle communication.

### SUMMARY

The present disclosure provides a technique capable of improving convenience for users who want to charge their vehicles.

The present disclosure can be regarded as an information processing device. The information processing device includes, for example, a control device configured to receive a first request sent from a first terminal corresponding to a first vehicle, the first request being a request for information on a second vehicle having a power supply function, acquire a scheduled parking location of the second vehicle and a scheduled parking time period of the second vehicle, and send first information including the scheduled parking location of the second vehicle and the scheduled parking time period of the second vehicle to the first terminal.

The present disclosure can also be regarded as an information processing method in which a computer performs a process of the above information processing device. The present disclosure can also be regarded as an information processing program that causes a computer to perform the above information processing method, or a non-transitory storage medium storing the information processing program.

According to the present disclosure, it is possible to provide a technique capable of improving convenience for users who want to charge their vehicles.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an overview of the system in the embodiment;

FIG. 2 is a diagram showing an example of the hardware configuration of a server in the embodiment;

FIG. 3 is a block diagram showing an example of a functional configuration of a server in the embodiment;

FIG. 4 is a diagram showing an example of information stored in a parking management DB in the embodiment; and

FIG. 5 is a flowchart showing a processing routine executed by the server in the embodiment.

### DETAILED DESCRIPTION OF EMBODIMENTS

In the information processing device according to the present disclosure, the control unit receives the first request transmitted from the first terminal. The first terminal is, for example, a mobile terminal used by the user of the first vehicle, or an in-vehicle terminal mounted on the first vehicle. The first vehicle is, for example, a Plug-in Hybrid Electric Vehicle (PHEV), a Battery Electric Vehicle (BEV), or the like. The first request is a signal requesting information for a second vehicle. The second vehicle is, for example, a PHEV or BEV having a power supply function. An information processing device according to the present disclosure is, for example, a server or the like that communicates with a first terminal and a second terminal via a network.

The control unit acquires the scheduled parking location and the scheduled parking time period of the second vehicle when receiving the first request. The control unit transmits first information including the acquired scheduled parking location and the acquired scheduled parking time period to the first terminal. Thereby, the user of the first vehicle can grasp the scheduled parking location and the scheduled parking time period of the second vehicle through the first terminal. As a result, the user of the first vehicle can more accurately determine whether the second vehicle can be used to charge the battery of the first vehicle.

Hereinafter, an embodiment of the present disclosure will be described with reference to the drawings. The hardware configuration, module configuration, functional configuration, and the like described in the following embodiments are not intended to limit the technical scope of the disclosure unless otherwise specified.

### Embodiment

In this embodiment, an example in which an information processing device according to the present disclosure is applied to a system for providing information on a vehicle having a power supply function will be described.

### Summary of System

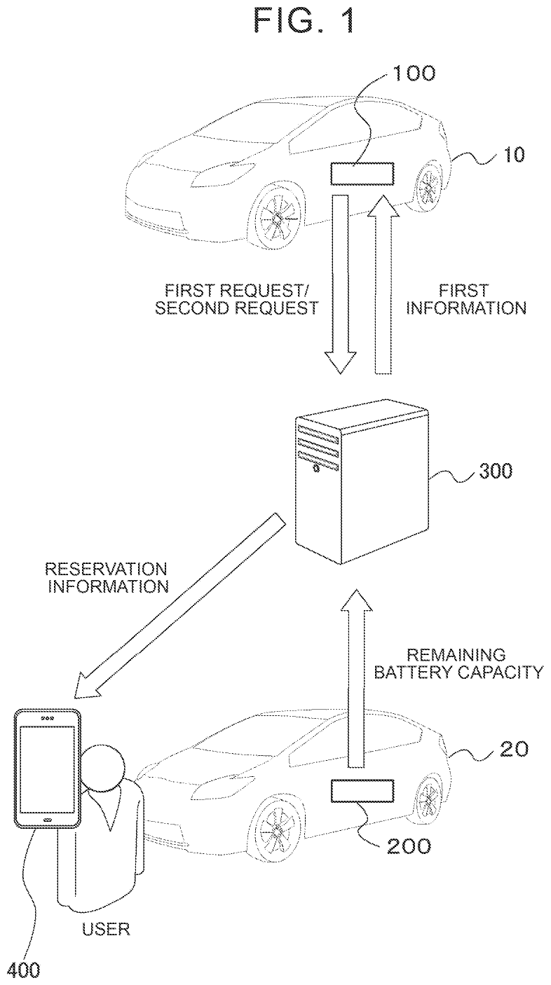

FIG. 1 is a diagram showing an overview of the system in this embodiment. The system in this embodiment includes a first in-vehicle device 100 mounted in a first vehicle 10, a second in-vehicle device 200 mounted in a second vehicle 20, a server 300, a user terminal 400, Consists of The first in-vehicle device 100, the second in-vehicle device 200, the server 300, and the user terminal 400 are connected via a network. Although only one second vehicle 20 (second in-vehicle device 200) is illustrated in the example shown in FIG. 1, a plurality of second vehicles 20 (second in-vehicle devices 200) is managed by the server 300.

The first vehicle 10 is a vehicle capable of charging a driving battery by power supply from the outside. The first vehicle 10 is, for example, a PHEV or BEV that runs using battery power as a drive source. The second vehicle 20 is a PHEV or BEV that runs using battery power as a drive source, and has a function of supplying power to other vehicles. In this embodiment, an example of using a company car as the second vehicle 20 will be described.

The first in-vehicle device 100 is a computer mounted in the first vehicle 10. The first in-vehicle device 100 in this embodiment has the function of a car navigation system. That is, the first in-vehicle device 100 accepts input of a departure point and a destination by the user of the first vehicle 10, and presents the user with a scheduled travel route from the departure point to the destination. The scheduled travel route is presented, for example, in the form of displaying the scheduled travel route on a map.

When displaying the scheduled travel route of the first vehicle 10 on the map, the first in-vehicle device 100 of the present embodiment places the second vehicle 20 at the scheduled parking location of the second vehicle 20 on the map. It also has a function of displaying the scheduled parking time period (scheduled parking start date and time and scheduled parking end date and time) and information indicating the remaining battery capacity. When the scheduled travel route of the first vehicle 10 is determined, the first in-vehicle device 100 transmits a first request to the server 300 to acquire the scheduled parking location, scheduled parking time period, and remaining battery capacity of the second vehicle 20. The first request is a signal requesting information on the second vehicle 20 and includes information on the scheduled travel route of the first vehicle 10.

In addition, the first in-vehicle device 100 of the present embodiment has a function of accepting a reservation for battery charging from the second vehicle 20 to the first vehicle 10 from the user, and a signal (second request) to the server 300. The second request includes, for example, identification information (vehicle ID described later) of the second vehicle 20 to be reserved.

The server 300 of this embodiment generates the first information when receiving the first request transmitted from the first in-vehicle device 100, and transmits the generated first information to the first in-vehicle device 100. The first information is information including the scheduled parking location, parking time period, and remaining battery capacity of the second vehicle 20. The remaining battery capacity of the second vehicle 20 is acquired by the server 300 communicating with the second in-vehicle device 200.

Further, the server 300 of the present embodiment transmits reservation information to the user terminal 400 used by the user of the second vehicle 20 when receiving the second request transmitted from the first in-vehicle device 100. The reservation information includes information on the scheduled parking location and the scheduled parking time period when the second vehicle 20 is used to charge the battery of the first vehicle 10. Note that while the second vehicle 20 is being used to charge the battery of the first vehicle 10 (scheduled parking time period), the user of the second vehicle 20 cannot use the second vehicle 20. Therefore, it is conceivable that the user of the second vehicle 20 may have too much time. Therefore, the reservation information may include information about recommended spots (for example, sightseeing spots, amusement facilities, restaurants, etc.) located around the scheduled parking location to be reserved. This allows the user of the second vehicle 20 to spend the time until the scheduled parking end date and time at the recommended spot.

The second in-vehicle device 200 is a computer mounted on the second vehicle 20. The second in-vehicle device 200 in this embodiment has a function to acquire the remaining battery capacity of the second vehicle 20 and transmitting the acquired remaining battery capacity to the server 300 in response to a request from the server 300.

The user terminal 400 has a function of presenting the reservation information to the user of the second vehicle 20 when the reservation information transmitted from the server 300 is received.

In this embodiment, the first in-vehicle device 100 corresponds to the “first terminal” according to the present disclosure. The user terminal 400 in this embodiment corresponds to the “second terminal” according to the present disclosure. The server 300 in this embodiment corresponds to the “information processing device” according to the present disclosure. In addition, as the “first terminal” according to the present disclosure, a mobile terminal (for example, a smartphone, a tablet terminal, etc.) used by the user of the first vehicle 10 is used instead of the first in-vehicle device 100. In that case, an application program for providing car navigation services should be installed in the mobile terminal.

### Configuration of Server

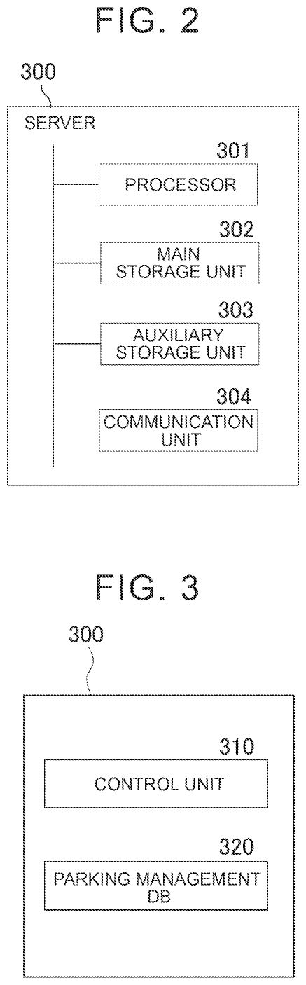

FIG. 2 is a diagram showing an example of the hardware configuration of the server 300 in this embodiment. The server 300 in this embodiment includes a processor 301, a main storage unit 302, an auxiliary storage unit 303, and a communication unit 304, as shown in FIG. 2. In the example shown in FIG. 2, only the hardware configuration related to the service of providing information on vehicles having power supply functions is extracted and illustrated, but server 300 may include other hardware configurations.

The processor 301 is an arithmetic processing device such as a Central Processing Unit (CPU) or a Digital Signal Processor (DSP). The processor 301 loads a program stored in the auxiliary storage unit 303 into the main storage unit 302, executes it, and controls the server 300 through the execution.

The main storage unit 302 includes semiconductor memories such as random access memory (RAM) and read only memory (ROM). The main storage unit 302 provides a storage area and work area for loading programs stored in the auxiliary storage unit 303. Further, the main storage unit 302 is used as a buffer for arithmetic processing by the processor 301.

The auxiliary storage unit 303 is, for example, Erasable Programmable ROM (EPROM) or Hard Disk Drive (HDD). The auxiliary storage unit 303 can include removable media, i.e., portable recording media. A removable medium is, for example, a disk recording medium such as a Universal Serial Bus (USB) memory, a Compact Disc (CD), or a Digital Versatile Disc (DVD). The auxiliary storage unit 303 stores various programs and data used by the processor 301 when executing each program.

The programs stored in the auxiliary storage unit 303 include, in addition to the operating system (OS), a dedicated program for causing the processor 301 to execute processing related to a service that provides information on vehicles having a power supply function.

A communication unit 304 is an interface for connecting the server 300 to a network. The network is, for example, a Wide Area Network (WAN), which is a worldwide public communication network such as the Internet, or other communication network. Communication unit 304, for example, Long Term Evolution (LTE), LTE-Advanced, 5th Generation (5G), and 6th Generation (6G), such as mobile communication systems, Wi-Fi (registered trademark) and other wireless communication systems, or Local Area Network (LAN), etc., to connect to a network. In this embodiment, the communication unit 304 communicates with the first in-vehicle device 100, the second in-vehicle device 200, and the user terminal 400 through the network.

### Server Functional Configuration

A functional configuration of the server 300 in this embodiment will be described with reference to FIG. 3. FIG. 3 is a block diagram showing an example of the functional configuration of the server 300. As shown in FIG. 3, the server 300 in this embodiment has a control unit 310 and a parking management DB 320 as its functional components. Note that the functional components of the server 300 are not limited to the example shown in FIG. 3, and components may be omitted, replaced, or added as appropriate.

Here, of the control unit 310 and the parking management DB 320, the parking management DB 320 will be described first. The parking management DB 320 stores information about the parking schedule of the second vehicle 20 for a predetermined period (for example, a period of several days to several weeks). The parking management DB 320 of this embodiment is a database constructed in the auxiliary storage unit 303 of the server 300 by the processor 301 of the server 300 executing a database management system (DBMS) program. At that time, the parking management DB 320 may be constructed as a relational database. Note that the parking management DB 320 in this embodiment corresponds to the “first database” according to the present disclosure.

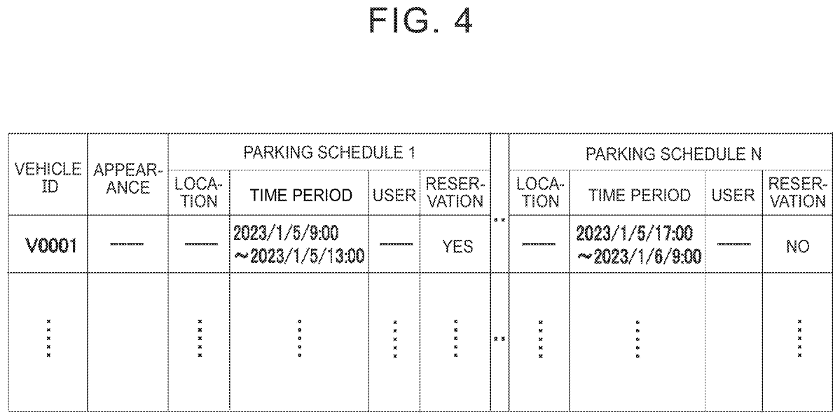

FIG. 4 is a diagram showing an example of information stored in the parking management DB 320 in this embodiment. The parking management DB 320 in this embodiment includes a plurality of records (hereinafter sometimes referred to as “parking information records”) corresponding to the plurality of second vehicles 20 under the management of the server 300, as illustrated in FIG. 4. Each parking information record has fields such as vehicle ID, appearance, and parking schedule, as shown in FIG. 4.

Information (vehicle ID) for identifying each of the plurality of second vehicles 20 under the control of server 300 by server 300 is registered in the vehicle ID field. In the appearance field, information indicating appearance features (for example, a character string of an automobile registration number mark, a vehicle type, a body color, etc.) for identifying an individual second vehicle 20 by a person other than the user of the second vehicle 20 (for example, a user of the first vehicle 10) is registered.

Information indicating the parking schedule of each second vehicle 20 in a predetermined period is registered in the parking schedule field. In the example shown in FIG. 4, the parking schedule field is divided into location, time period, user, and reservation subfields. In the location field, information (for example, latitude and longitude, address, etc.) indicating the location where each second vehicle 20 is to be parked is registered. In the time period field, the time period (scheduled parking start date and time and scheduled parking end date and time) during which each second vehicle 20 is to be parked at the scheduled parking location is registered. In the user field, identification information of a user who uses each second vehicle 20 (for example, an employee of a company who uses the second vehicle 20 as a company car) is registered. In this embodiment, information indicating the e-mail address of the user terminal 400 of the user who uses each second vehicle 20 is registered in the user field. Information indicating whether there is a reservation for the second vehicle 20 to charge the battery of another vehicle is registered in the reservation field. For example, in each of the second vehicles 20, “Yes” is registered in the reservation field for the reserved parking schedule, and “No” is registered in the reservation field for the unreserved parking schedule.

For the second vehicle 20 for which a plurality of parking schedules is set during a predetermined period, a plurality of parking schedule fields (“parking schedule 1” to “parking schedule N (N is a natural number)” in FIG. 4) is set. At that time, the user field is provided for each parking schedule because, in the second vehicle 20 used as a company car, the user (employee) who uses the second vehicle 20 may be different for each parking schedule.

Information indicating the parking schedule of the second vehicle 20 for a predetermined period (scheduled parking date and time, scheduled parking time period, e-mail address of the user terminal 400) is periodically sent from a company that uses the second vehicle 20 as a company vehicle is provided and registered in the parking management DB 320. The configuration of the parking information record is not limited to the example shown in FIG. 4, and fields can be added, changed, or deleted as appropriate.

Here, returning to FIG. 3, the control unit 310 of the server 300 will be described. Control unit 310 is implemented by processor 301 of server 300 loading a dedicated program stored in auxiliary storage unit 303 into main storage unit 302 and executing the program. Note that the control unit 310 may be realized by a hardware circuit such as an Application Specific Integrated Circuit (ASIC) or a Field Programmable Gate Array (FPGA).

The control unit 310 determines the second vehicle 20 as the target of the first information, triggered by the reception of the first request by the communication unit 304. First, the control unit 310 accesses the parking information record of the parking management DB 320 and determines whether “no” is registered in the reservation field of the parking schedule field. When “no” is registered in the reservation field, the control unit 310, based on the information registered in the scheduled parking time period field of the parking schedule field, determines whether the parking schedule for the current day (the day the first request is received, or the scheduled date of movement of the first vehicle 10) is registered. At this time, if the scheduled parking time period registered in the time period field includes at least a part of the time period of the current day, the control unit 310 determines that the parking schedule for the current day is registered. If the scheduled parking time period registered in the time period field does not include any time period for the current day, the control unit 310 determines that the parking schedule for the current day is not registered. All parking information records registered in the parking management DB 320 are checked to determine whether the parking schedule for the day is registered.

The control unit 310 excludes the second vehicle 20 for which “Yes” is registered in the reservation field and the second vehicle 20 for which the parking schedule for the day is not registered from the objects of the first information. On the other hand, for the second vehicle 20 for which “No” is registered in the reservation field and for which the parking schedule for the day is registered, the control unit 310 calculates the length of time (first length of time Tl1) for which the second vehicle 20 is scheduled to be parked at the scheduled parking location. At this time, the control unit 310 may calculate the length of time from the scheduled parking start date and time to the scheduled parking end date and time as the first length of time Tl1. Alternatively, the control unit 310 may calculate the length of time for the current day from the scheduled parking start date and time to the scheduled parking end date and time as the first length of time Tl1. Control unit 310 determines whether the calculated first length of time Tl1 is equal to or greater than a predetermined length of time Tlthre1. The predetermined length of time Tlthre1 is, for example, the minimum length of charging time (for example, about 3 hours) required to charge the battery of the first vehicle 10 using the second vehicle 20.

The control unit 310 excludes the second vehicle 20 for which the first length of time Tl1 is less than the predetermined length of time Tlthre1 from the target of the first information. On the other hand, for the second vehicle 20 determined to have the first length of time Tl1 equal to or greater than the predetermined length of time Tlthre1, the control unit 310 calculates the length of distance (first length of distance L1) from the scheduled travel route of the first vehicle 10 to the scheduled parking location, based on the information registered in the location field. The control unit 310 determines whether the calculated first length of distance L1 is within a predetermined length of distance Lthre1. The predetermined length of distance Lthre1 is, for example, the length of distance (for example, several hundred meters to several kilometers) shorter than the length of distance that the first vehicle 10 can travel with the remaining battery capacity even when the remaining battery capacity of the first vehicle 10 has decreased to a predetermined threshold (for example, the remaining battery capacity at which a warning prompting battery charging is output).

The control unit 310 excludes the second vehicle 20 determined to have the first length of distance L1 greater than the predetermined length of distance Lthre1 from the target of the first information. On the other hand, the control unit 310 determines that the second vehicle 20, for which the first length of distance L1 is within the predetermined length of distance Lthre1, is the target of the first information.

According to the above method, of the plurality of second vehicles 20 under the management of the server 300, the second vehicle 20 for which the parking schedule for the day is set, the first length of time Tl1 is equal to or greater than the predetermined length of time Tlthre1, and the first length of distance L1 is within a predetermined length of distance Lthre1 is determined to be a target of the first information.

When the second vehicle 20 that is the target of the first information is determined, the control unit 310 communicates with the second in-vehicle device 200 of the second vehicle 20 through the communication unit 304 to acquire the remaining battery capacity.

Control unit 310 generates first information for the second vehicle 20 determined to be the target of the first information. The first information is information including the vehicle ID of the second vehicle 20 determined as the target of the first information, the parking schedule (scheduled parking location and scheduled parking time period), and remaining battery capacity. At this time, for the second vehicle 20 for which a plurality of parking schedules are registered in the parking management DB 320, only the parking schedule including the parking schedule for the current day is included in the first information among the plurality of parking schedules. Control unit 310 transmits the generated first information to the first in-vehicle device 100 through communication unit 304. In the first in-vehicle device 100 that has received the first information, the scheduled travel route of the first vehicle 10 and the scheduled parking location of the second vehicle 20 are displayed on the map. Further, in the first in-vehicle device 100, the scheduled parking time period and remaining battery capacity of the second vehicle 20 are displayed at the scheduled parking location of the second vehicle 20 on the map.

Also, when the second request is received by the communication unit 304 of the server 300, the control unit 310 transmits reservation information to the user terminal 400 used by the user of the second vehicle 20. The second request is a signal requesting reservation of battery charging of the first vehicle 10 by the second vehicle 20, and includes the vehicle ID and parking schedule of the second vehicle 20 desired by the user. When the communication unit 304 receives such a second request, the control unit 310 accesses the parking management DB 320 with the vehicle ID included in the second request as an argument, and registers the vehicle ID in the vehicle ID field. Identifies a parking information record whose information matches the vehicle ID included in the second request. The control unit 310 identifies a parking schedule field in which information matching the parking schedule included in the second request is registered among the parking schedule fields registered in the identified parking information record. Control unit 310 registers “Yes” in the reservation field of the specified parking schedule field. Further, control unit 310 reads information (e-mail address) registered in the user field of the specified parking schedule field. Control unit 310 transmits reservation information to user terminal 400 having the read e-mail address. The reservation information includes information on the scheduled parking location and the scheduled parking time period when the second vehicle 20 is used to charge the battery of the first vehicle 10, as well as information on recommended spots located around the scheduled parking location.

After transmitting the reservation information to the user terminal 400, the control unit 310 may transmit information indicating that the reservation has been completed to the first in-vehicle device 100. The information indicating that the reservation has been completed may include information indicating the external features of the second vehicle 20 to be reserved (information registered in the appearance field of the parking information record). This allows the user of the first vehicle 10 to identify the second vehicle 20 when arriving at the scheduled parking location of the second vehicle 20.

### Processing Flow

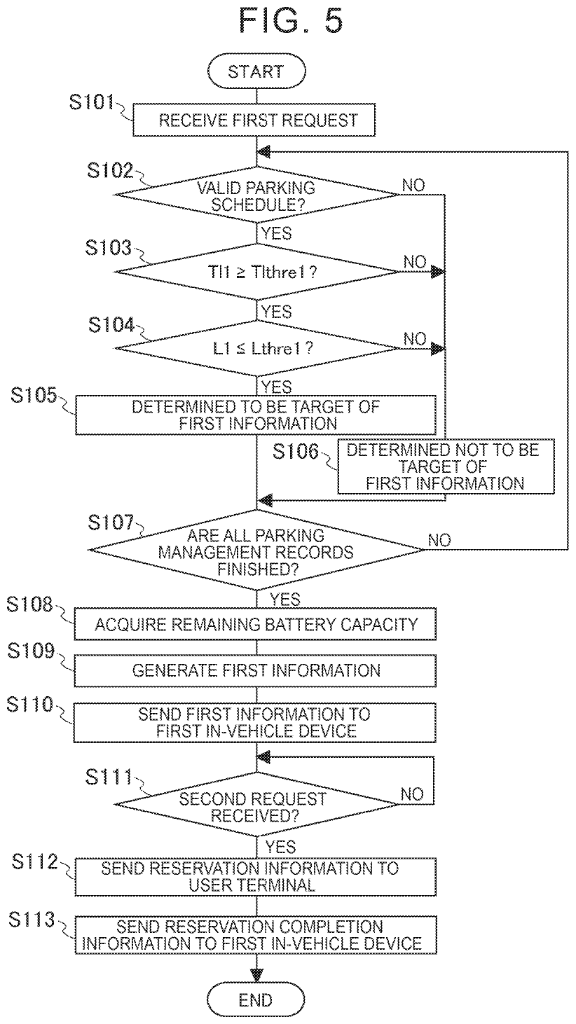

Next, the flow of processing executed by the server 300 in this embodiment will be described with reference to FIG. 5. FIG. 5 is a flowchart showing a processing routine executed by the server 300 triggered by the reception of the first request by the communication unit 304 of the server 300. Although the entity that executes the processing routine of FIG. 5 is the processor 301 of the server 300, it is herein assumed that the functional component (control unit 310) of the server 300 is the entity that executes the processing routine.

In the processing routine of FIG. 5, the first request is passed from the communication unit 304 to the control unit 310 when the communication unit 304 of the server 300 receives the first request. Thereby, the control unit 310 receives the first request through the communication unit 304 (S101). After completing the processing of S101, the control unit 310 executes the processing of S102.

Note that the processing from S102 to S106 in FIG. 5 is executed for all parking information records registered in the parking management DB 320. First, in S102, the control unit 310 determines whether a valid parking schedule is registered in the target parking information record. A valid parking schedule is such a parking schedule that “No” is registered in the reservation field of the parking schedule field, and the scheduled parking time period registered in the scheduled parking time period field of the parking schedule field is at least a part of the time period of the current day. When it is determined that a valid parking schedule is registered in the target parking information record (Yes in S102), the control unit 310 executes the process of S103.

In S103, the control unit 310 calculates the first length of time Tl1 based on the information registered in the time period field of the parking schedule field in which the valid parking schedule is registered. Specifically, control unit 310 calculates the length of time from the scheduled parking start date and time to the scheduled parking end date and time as first length of time Tl1. Alternatively, the control unit 310 may calculate the length of time for the current day from the scheduled parking start date and time to the scheduled parking end date and time as the first length of time Tl1. Control unit 310 determines whether the calculated first length of time Tl11 is equal to or greater than a predetermined length of time Tlthre1. When the first length of time Tl1 is equal to or greater than the predetermined length of time Tlthre1 (Yes in S103), control unit 310 executes the process of S104.

In S104, the control unit 310 determines the first length of distance L1 (length of distance from the scheduled travel route of the first vehicle 10 to the scheduled parking location) based on the information registered in the location field of the parking schedule field in which the valid parking schedule is registered. Control unit 310 determines whether the calculated first length of distance L1 is equal to or less than the predetermined length of distance Lthre1. When the first length of distance L1 is equal to or less than the predetermined length of distance Lthre1 (Yes in S104), the control unit 310 executes the process of S105.

In S105, the control unit 310 determines the second vehicle 20 corresponding to the target parking information record as the target of the first information.

It should be noted that, when No in any of S102 to S104, the control unit 310 executes the process of S106. In S106, the control unit 310 determines that the second vehicle 20 corresponding to the target parking information record is excluded from the first information.

After completing the processing of S105 or S106, the control unit 310 executes the processing of S107. In S107, the control unit 310 determines whether the processes from S102 to S106 have been executed for all parking information records registered in the parking management DB 320. If the processing of S102 to S106 has not been completed for all the parking information records registered in the parking management DB 320 (No in S107), the control unit 310 controls the following target parking information record: The processing from S102 to S106 is executed. Further, when the processing of S102 to S106 has been completed for all parking information records registered in the parking management DB 320 (Yes in S107), the control unit 310 executes the processing of S108.

In S108, the control unit 310 communicates through the communication unit 304 with the second in-vehicle device 200 of the second vehicle 20 determined to be the target of the first information in S105, and thus acquires the remaining battery capacity of the second vehicle 20. Note that if there is a plurality of second vehicles 20 determined to be the target of the first information, the control unit 310 acquires the remaining battery capacity for each of the plurality of second vehicles 20. After completing the processing of S108, the control unit 310 executes the processing of S109.

In S109, the control unit 310 generates the first information for the second vehicle 20 determined as the target of the first information in S105. The first information is information including the vehicle ID of the second vehicle 20 determined as the target of the first information, the parking schedule (scheduled parking location and scheduled parking time period), and remaining battery capacity. Note that when there are a plurality of second vehicles 20 determined to be the target of the first information, the control unit 310 generates the first information for each of the plurality of second vehicles 20. Further, for the second vehicle 20 for which a plurality of parking schedules are registered in the parking management DB 320, only the parking schedule including the parking schedule for the current day is included in the first information among the plurality of parking schedules. After executing the process of S109, the control unit 310 executes the process of S110.

In S110, the control unit 310 transmits the first information generated in S109 to the first in-vehicle device 100 of the first vehicle 10 through the communication unit 304. After completing the processing of S110, the control unit 310 executes the processing of S111.

In S111, the control unit 310 determines whether the communication unit 304 has received the second request from the first in-vehicle device 100. The second request is a signal requesting reservation of battery charging of the first vehicle 10 by the second vehicle 20, and includes the vehicle ID and parking schedule of the second vehicle 20 desired by the user. When the communication unit 304 has not received the second request (No in S111), the control unit 310 waits to receive the second request. Note that if the communication unit 304 does not receive the second request within a preset timeout period, the control unit 310 may terminate execution of this processing routine. On the other hand, if the communication unit 304 has received the second request (Yes in S111), the control unit 310 executes the process of S112.

In S112, the control unit 310 accesses the parking management DB 320 using the vehicle ID included in the second request as an argument, and identifies the parking information record in which the information registered in the vehicle ID field matches the vehicle ID included in the second request. Control unit 310 identifies a parking schedule field in which information matching the parking schedule included in the second request is registered among the parking schedule fields registered in the identified parking information record. Control unit 310 registers “Yes” in the reservation field of the specified parking schedule field. Further, control unit 310 reads information (e-mail address) registered in the user field of the specified parking schedule field. Control unit 310 transmits reservation information to user terminal 400 having the read e-mail address. The reservation information includes information on the scheduled parking location and the scheduled parking time period when the second vehicle 20 is used to charge the battery of the first vehicle 10, as well as information on recommended spots located around the scheduled parking location. After completing the processing of S112, the control unit 310 executes the processing of S113.

In S113, control unit 310 transmits information indicating that the reservation has been completed (reservation completion information) to first in-vehicle device 100 of first vehicle 10 through communication unit 304. The reservation completion information may include, in addition to information indicating that the reservation has been completed, information indicating the external features of the second vehicle 20 to be reserved. The information indicating the appearance features of the second vehicle 20 to be reserved is, for example, information registered in the appearance field of the parking information record specified in S112 (character string of automobile registration number, vehicle type, and body color, etc.). After completing the process of S113, the control unit 310 ends the execution of this process routine.

### Actions and Effects of the Embodiment

According to the embodiment described above, when the first in-vehicle device 100 displays the scheduled travel route of the first vehicle 10 on the map, information indicating the scheduled parking time period of the second vehicle 20 (scheduled parking start date and time and scheduled parking end date and time) and the remaining battery capacity of the second vehicle 20 can be displayed at the scheduled parking location of the second vehicle 20 on the map. As a result, the user of the first vehicle 10 can determine whether the battery of the first vehicle 10 can be charged using the second vehicle 20 and which second vehicle 20 can be used while traveling along the scheduled travel route can be used to more accurately determine whether the battery of the first vehicle 10 should be charged.

The second vehicle 20 displayed on the map by the first in-vehicle device 100 is limited to the second vehicle 20 in which the first length of time Tl1 is equal to or greater than the predetermined length of time Tlthre1, and the first length of distance L1 is equal to or less than the predetermined length of distance Lthre1. As a result, it is possible to suppress situations in which the time for charging the battery of the first vehicle 10 using the second vehicle 20 is insufficient, and the first vehicle 10 cannot reach the scheduled parking location of the second vehicle 20.

Also, the user of the second vehicle 20 is notified of the reservation information through the user terminal 400. As a result, it is possible to prevent the occurrence of the situations in which the user of the second vehicle 20 parks the second vehicle 20 at a location different from the scheduled parking location or moves the second vehicle 20 during the scheduled parking time period.

Therefore, according to the present embodiment, it is possible to improve convenience for the user who wishes to charge the first vehicle 10.

### Others

The above-described embodiment is merely an example, and the present disclosure can be modified as appropriate without departing from the scope of the present disclosure. Further, the processes described as being executed by one device may be shared and executed by a plurality of devices. Alternatively, the processes described as being executed by different devices may be executed by one device. In the computer system, it is possible to flexibly change the hardware configuration for implementing each function.

What is claimed is:

1. An information processing device comprising a control unit, the control unit being configured to
receive a first request sent from a first terminal corresponding to a first vehicle, the first request being a request for information on a second vehicle having a power supply function,
acquire a scheduled parking location of the second vehicle and a scheduled parking time period of the second vehicle, and
send first information including the scheduled parking location of the second vehicle and the scheduled parking time period of the second vehicle to the first terminal.

2. The information processing device according to claim 1, wherein the control unit is configured to further acquire a remaining battery capacity of the second vehicle and includes the remaining battery capacity in the first information.

3. The information processing device according to claim 1, further comprising a first database that stores the scheduled parking location of the second vehicle and the scheduled parking time period of the second vehicle in association with each other, wherein the control unit is configured to
determine based on information in the first database whether a first length of time is equal to or greater than a predetermined length of time, the first length of time being a length of time for which the second vehicle is scheduled to be parked at the scheduled parking location, and
when determination is made that the first length of time is equal to or greater than the predetermined length of time, send the first information to the first terminal.

4. The information processing device according to claim 1, further comprising a first database that stores the scheduled parking location of the second vehicle and the scheduled parking time period of the second vehicle in association with each other, wherein the control unit is configured to
acquire a scheduled travel route of the first vehicle,
determine based on the scheduled travel route and information in the first database whether a first length of distance is equal to or less than a predetermined length of distance, the first length of distance being a length of distance from the scheduled travel route to the scheduled parking location, and
when determination is made that the first length of distance is equal to or less than the predetermined length of distance, send the first information to the first terminal.

5. The information processing device according to claim 1, wherein the control unit is configured to
receive from the first terminal a reservation for power supply from the second vehicle to the first vehicle, and
send information on the reservation to a second terminal used by a user of the second vehicle.
